(19) United States
(12) Patent Application Publication
(10) Pub. No.: US 2024/0097301 A1
(43) Pub. Date: Mar. 21, 2024

(54) Integrated Choke Assembly

(71) Applicant: PHIHONG TECHNOLOGY CO., LTD., Taoyuan City (TW)

(72) Inventors: Pang-Chuan CHEN, Taoyuan City (TW); Chih-Shin HUANG, Taoyuan City (TW); Shu-Cheng LEE, Taoyuan City (TW)

(21) Appl. No.: 17/966,840

(22) Filed: Oct. 16, 2022

(30) Foreign Application Priority Data
Sep. 15, 2022 (TW) 111210053

(51) Int. Cl. H01P 1/22; H01F 27/24; H01F 27/28; H01F 27/34

(52) U.S. Cl. CPC H01P 1/22; H01F 27/24; H01F 27/28; H01F 27/34

(57) ABSTRACT

The present invention discloses an integrated choke assembly comprising: a base having a main body structure, a first protruding part and a second protruding part. A first choke has a first magnetic core and a first winding, wherein the first protruding part is arranged through the first opening of the first magnetic core so that the first choke is arranged on the upper surface of the main body structure, and the first winding is wound on the first magnetic core. A second choke has a second magnetic core and a second winding, wherein the second protruding part is arranged through the second opening of the second magnetic core so that the second choke is arranged on the lower surface of the main body structure, and the second winding is wound on the second magnetic core.

### CROSS-REFERENCE STATEMENT

The present application is based on, and claims priority from, Taiwan Patent Application Serial Number 111210053, filed Sep. 15, 2022, the disclosure of which is hereby incorporated by reference herein in its entirety.

### BACKGROUND

### Technical Field

The present invention relates to a chock structure, and more particularly, an integrated choke assembly.

### Related Art

When an electrical appliance needs to use an alternating current (AC) power supply for operation, noise current may be carried within the current supplied by the AC power supply due to the power supply, the operation of the parasitic capacitance or stray capacitance of the high-frequency transformer or other components, which is called electromagnetic interference (EMI).

Generally speaking, the noise generated by the operation of AC power supply includes differential mode noise and common mode noise, and the electromagnetic interference filter can be used as the first line of defense against electromagnetic radiation of the power supply. The electromagnetic interference filter mainly consists of a choke and a capacitor, wherein the choke is used to suppress noise which may be constructed by at least one winding, a magnetic core and a winding frame for winding the winding. That is, a choke functions as a low impedance coil used to attenuate high-frequency current in a circuit. Because of its low impedance and high current resistance, it is often used in the power supply of electronic equipment.

The function of the choke is to stabilize the current in the circuit and achieve the effect of filtering noise. The function is similar to that of the capacitor. It also stores and releases the electrical energy in the circuit to adjust the stability of the current. Compared with the capacitor, which stores the electrical energy in the form of an electric field (charge), the choke is achieved in the form of a magnetic field.

In addition, the choke generates an electromotive force due to the change of the passing current, thereby resisting the change of the current. As no current passes through the circuit, the choke will try to block the current flowing through it when the circuit is activated, and as current passes through the circuit, the choke will try to keep the current unchanged when the circuit is disconnected. The structure of choke is similar to that of transformer, but it only consists of one winding, which is widely used in power components.

Although the EMI filter can indeed suppress noise generation by the choke, the circuit architecture of the EMI filter with the function of first-order filtering is a two-way filter circuit to receive dual input power correspondingly. That is, in order that the EMI filter receiving the two sets of power supplies can suppress noise, the conventional practice can only set two independent chokes in the EMI filter, and connect each choke to one of the filter circuits, so that the noise of the power supply received by the corresponding filter circuit can be suppressed by each choke.

As described above, when two independent chokes are required for the EMI filter, the cost will be increased. More space is required to accommodate the two independent chokes, and the manufacturing time is increased. In addition, when the voltage values of the two sets of power supplies received by the two input terminals of the EMI filter are different, the current flowing into the choke from the positive terminal of each filter circuit may not be the same as the current flowing out of the negative terminal of each filter circuit through the choke, so that the choke is in unbalanced and saturated state, resulting in the impedance on the choke becoming extremely small. Accordingly, the current flowing through the choke will become very large, so that the choke and other components inside the electromagnetic interference filter will burn out instantly or fail to operate normally.

Therefore, in order to improve the above-mentioned shortcomings of the prior arts, the present invention proposes a novel choke structure to improve the above-mentioned shortcomings.

### SUMMARY

In view of the disadvantages of the above conventional technology, the technical means of the present invention lies in integrating two chokes on the identical base.

According to one aspect of the present invention, the technical means for solving the problem is to provide an integrated choke assembly.

According to one aspect of the present invention, an integrated choke assembly is disclosed. The integrated choke assembly comprises a base, wherein a first protruding portion is on an upper surface of the base and a second protruding portion is on a lower surface of the base; a first choke configured on the first protruding portion so that the first choke is configured on the upper surface of the base; and a second choke configured on the second protruding portion so that the second choke is configured on the lower surface of the base.

According to another aspect of the present invention, the base includes a plurality of pins, such as two pairs of pins separated from each other.

According to another aspect of the present invention, the base is made of an insulating material, including bakelite or plastic.

According to yet another aspect of the present invention, the first choke includes a first magnetic core and a first winding set wound on the first magnetic core, and the second choke includes a second magnetic core and a second winding set wound on the second magnetic core. The first choke is a high-frequency EMI suppression choke or a low-frequency EMI suppression choke. The second choke is a high-frequency EMI suppression choke or a low-frequency EMI suppression choke.

According to one aspect of the present invention, the first magnetic core is an annular first magnetic core and the second magnetic core is an annular second magnetic core.

According to another aspect of the present invention, a coil interval of the first winding set wound on the first magnetic core are the same, and a coil interval of the second winding set wound on the second magnetic core are the same.

The above description is to explain the purpose, technical means and achievable effects of the present invention. Those familiar technologies in the relevant field can more clearly understand the present invention through the following embodiments and the accompanying schematic description and the scope of this application.

### BRIEF DESCRIPTION OF THE DRAWINGS

FIG. 1 illustrates a three-dimensional view of the integrated choke assembly of the present invention.

FIGS. 2(a) to 2(d) illustrate front, rear, top and bottom view of the integrated choke assembly of the present invention, respectively.

FIG. 3 illustrates an exploded view of the structure of the integrated choke assembly of the present invention.

FIG. 4 illustrates an exploded view of the structure of the integrated choke assembly of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The purpose of the present invention is to improve the structure for suppressing electromagnetic interference (EMI) on the circuit. Since it is necessary to suppress noise of high-frequency and low-frequency, two different chokes are used for suppression respectively. In conventional structure of chokes, the two types of chokes are placed on the respective pre-determined (reserved) space on the printed circuit board (PCB). Based on this point of view, the new scheme of the present invention can integrate the two types of chokes on the identical base (substrate) to form an integrated choke assembly, and the improved structure can produce an unexpected effects and applications.

For example, in one embodiment, the present invention integrates the low frequency EMI suppression choke and the high frequency EMI suppression choke onto the identical base. The structures of the two chokes and the base of the present invention are not limited by the following description and drawings.

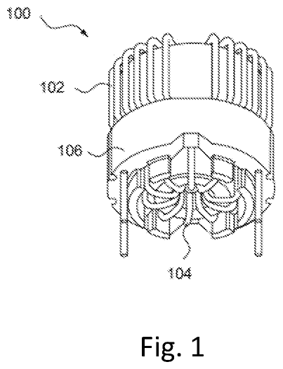

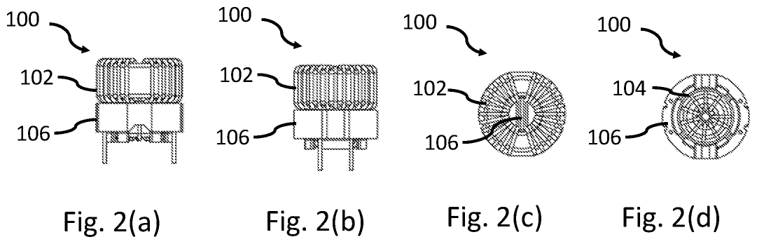

Therefore, based on the above purpose, please refer to FIG. 1, the present invention provides an integrated choke assembly 100. In this embodiment, FIG. 1 shows a three-dimensional view of the integrated choke assembly 100. In addition, please refer to FIG. 2(a) to FIG. 2(d), FIG. 2(a) shows a front view of the integrated choke assembly 100, FIG. 2(b) shows a rear view of the integrated choke assembly 100, FIG. 2(c) shows a top view of the integrated choke assembly 100, and FIG. 2(d) shows a bottom view of the integrated choke assembly 100.

As shown in FIG. 1 and FIG. 2(a) to FIG. 2(d), the integrated choke assembly 100 includes a first choke 102, a second choke 104 and a common base 106. In one embodiment, the first choke 102 is for suppressing high frequency electromagnetic interference, and the second choke 104 is for suppressing low frequency electromagnetic interference, wherein high frequency and low frequency are relative values, and the range of frequency can be determined based on the actual application. In other words, the integrated choke assembly 100 of the present invention can be used as an impedance element for suppressing electromagnetic interference of two frequencies. In another embodiment, the first choke 102 is for suppressing low frequency electromagnetic interference, and the second choke 104 is for suppressing high frequency electromagnetic interference.

As shown in FIG. 1 and FIG. 2(a) to FIG. 2(d), the first choke 102 is disposed on the upper surface of the base 106, and the second choke 104 is disposed on the lower surface of the base 106. Since the first choke 102 and the second choke 104 are respectively arranged on the upper and lower sides of the identical base 106, the two chokes can be integrated on the identical base 106, which saves the use of one choke base.

In one embodiment, the first choke 102 is an impedance element or a passive element that can generate inductance to filter electromagnetic waves. The first choke 102 comprises a magnetic core, a first electrode, a second electrode and a winding set. The magnetic core is provided with an opening to facilitate the winding to wind on the magnetic core. The winding set has a first winding coil on the left side and a second winding coil on the right side. The first electrode is arranged at one end of the magnetic core, and the first electrode includes a first welding portion. The second electrode is provided at the other end of the magnetic core, and the second electrode includes a second welding portion. The winding set is wound on the magnetic core, and the winding set has a first leading out end welded to the first welding portion and a second leading out end welded to the second welding portion. The first welding portion, the first leading out end, the second welding portion and the second leading out end are all encapsulated in the receiving groove, which can avoid the risk of open circuit and oxidation due to improper operation of the solder joint in subsequent process and long-term exposure to the air, so as to improve the reliability of the product.

In one embodiment, the second choke 104 is an impedance element or a passive element that can generate inductance to filter electromagnetic waves. The second choke 104 comprises a magnetic core, a first electrode, a second electrode and a winding set. The magnetic core is provided with an opening to facilitate the winding to wind on the magnetic core. The first electrode is arranged at one end of the magnetic core, and the first electrode includes a first welding portion. The second electrode is provided at the other end of the magnetic core, and the second electrode includes a second welding portion. The winding set is wound on the magnetic core, and the winding set has a first leading out end welded to the first welding portion and a second leading out end welded to the second welding portion. The first welding portion, the first leading out end, the second welding portion and the second leading out end are all encapsulated in the receiving groove, which can avoid the risk of open circuit and oxidation due to improper operation of the solder joint in subsequent process and long-term exposure to the air, so as to improve the reliability of the product.

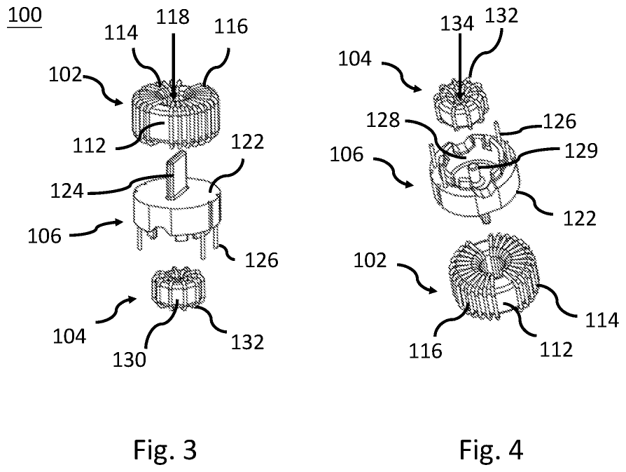

In a preferred embodiment of the present invention, please refer to FIG. 3 and FIG. 4, which show an exploded view of the structure of the integrated choke assembly 100 of the present invention. The first choke 102 is an impedance element, including a magnetic core 112, first and second electrodes (not shown), and a winding set. The magnetic core 112 is provided with an opening 118 to facilitate winding the winding set on the magnetic core 112. For example, the magnetic core 112 is an annular magnetic core having an opening. The winding set has a first winding coil 114 on the left side and a second winding coil 116 on the right side. The material of the magnetic core 112 includes manganese and zinc to suppress low-frequency electromagnetic interference.

In one embodiment, the magnetic core 112 includes other materials besides manganese and zinc, including the following compositions: Fe₂O₃ (62 wt %˜66 wt %), CuO (4 wt % 5 wt %), ZnO (14 wt %˜16 wt %), NiO (11 wt %˜14 wt %), the first auxiliary composition (0.25 wt %˜0.6 wt %), and the second auxiliary composition (0.2 wt %˜0.7 wt %); wherein the first auxiliary composition comprises at least Cr₂O₃ and MoO₃, and the second auxiliary composition comprises at least Co₂O₃, WO₃, SnO₂ and V₂O₅.

In one embodiment, the first winding coil 114 and the second winding coil 116 are both enameled wires. However, the first winding coil 114 and the second winding coil 116 may be other types of wires, not limited to enameled wires, according to the selection of actual applications and specific requirements.

In one embodiment, the coil intervals of the first winding coil 114 and the second winding coil 116 wound on the magnetic core 112 are the same. Specifically, the first winding coil 114 and the second winding coil 116 are relatively arranged on the magnetic core 112, and then are wound on the magnetic core 112 with the same coil interval and the same number of turns to eliminate the self-inductance of the coil, reduce the direct current (DC) resistance of the choke, and increase the operating current of the choke. It can be understood that the winding pattern of the first winding coil 112 and the second winding coil 116 can be appropriately modified, and are not limited to the above pattern.

The second choke 104 is an impedance element, including a magnetic core 130, first and second electrodes (not shown), and a winding set. The magnetic core 130 is provided with an opening 134 to facilitate winding the winding set on the magnetic core 130. For example, the magnetic core 130 is an annular magnetic core having an opening 134. The winding set has a winding coil 132 wound around the magnetic core 130. The material of the magnetic core 130 includes nickel and zinc to suppress high-frequency electromagnetic interference. In one embodiment, the coil intervals of the winding coil 132 wound on the magnetic core 130 are the same.

In one embodiment, the magnetic core 130 includes other auxiliary materials in addition to nickel and zinc, wherein the first auxiliary material includes the following compositions: Cr₂O₃ (0.01 wt % to 0.6 wt %) and MoO₃ (0.01 wt % to 0.15 wt %); the second auxiliary material includes the following compositions: Co₂O₃ (0.02 wt %˜0.10 wt %), WO₃ (0.05 wt % 0.15 wt %), SnO₂ (0.05 wt %˜0.1 wt %), V₂O₅ (0.01 wt %˜0.1 wt %). It can be understood that the first auxiliary material and the second auxiliary material may also include other materials according to the selection and requirement of the actual applications, and are not limited to the above materials.

The first choke 102 is configured on the base 106, and the protrusion 124 on the base 106 passes through the opening 118 of the first choke 102 to isolate the first winding coil 114 from the second winding coil 116. The base 106 is a separator and made of an insulating material for isolating the winding coil. For example, the material of the base 106 includes an insulating material such as bakelite or plastic. The base 106 has a main structure 122, an upper protrusion 124, four pins 126, a receiving space 128 and a lower protrusion 129. The main structure 122 allows the first choke 102 to be disposed on its upper surface. The opening 118 of the first choke 102 can allow the upper protrusion 124 on the main structure 122 to pass through, so that the first choke 102 can be disposed on the upper surface of the main structure 122. Similarly, the main body structure 122 allows the second choke 104 to be disposed on its lower surface. The opening 134 of the second choke 104 can allow the lower protrusion 129 on the back surface of the main structure 122 to pass through, so that the second choke 104 can be disposed in the accommodation space 128 on the lower surface of the main structure 122. In other words, the first choke 102 and the second choke 104 are respectively arranged on the upper and lower sides of the main structure 122 of the base 106. Since the base 106 itself is an insulating material, it can completely provide a good insulation between the first choke 102 and the second choke 104 and meet the requirements of safety regulation. The selection of the thickness of the main structure 122 of the base 106 can provide an isolation effect to solve the problem of insulation distance of safety regulation between the first choke 102 and the second choke 104.

The first choke 102 and the second choke 104 may be mounted on a circuit board. The base 106 includes two pairs of pins 126 spaced apart from each other. The first winding coil 114 is wound around the magnetic core 112 by a plurality of bent sections sequentially connected to each other. The first (inner) end and the second (outer) end of the first winding coil 114 are respectively welded to a pair of pins, and the first bending section and the last bending section of the plurality of bending sections are respectively connected to the first end and the second end. Similarly, the first (inner) end and the second (outer) end of the second winding coil 116 are respectively welded to a pair of pins, and the first bending section and the last bending section of the plurality of bending sections are respectively connected to the first end and the second end. The pins 126 are partially exposed to a certain position for mounting on the circuit board.

In summary, the integrated choke assembly (EMI choke base structure combined design) of the present invention has the following advantages: (1) it can save the space for placing the EMI suppression choke on the printed circuit board (PCB); (2) the use of one choke base can be omitted to reduce the cost; (3) the safety insulation distance between two chokes can be solved; (4) reduce manufacturing time of the integrated choke assembly and improve manufacturing efficiency.

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. An integrated choke assembly, comprising:
a base, wherein a first protruding portion is on an upper surface of said base and a second protruding portion is on a lower surface of said base;
a first choke configured on said first protruding portion so that said first choke is configured on said upper surface of said base; and
a second choke configured on said second protruding portion so that said second choke is configured on said lower surface of said base.

2. The assembly of claim 1, wherein said first choke is a high-frequency EMI suppression choke.

3. The assembly of claim 1, wherein said first choke is a low-frequency EMI suppression choke.

4. The assembly of claim 1, wherein said second choke is a high-frequency EMI suppression choke.

5. The assembly of claim 1, wherein said second choke is a low-frequency EMI suppression choke.

6. The assembly of claim 1, wherein said base includes two pairs of pins separated from each other.

7. The assembly of claim 1, wherein said base is made of an insulating material.

8. The assembly of claim 7, wherein said insulating material includes bakelite or plastic.

9. The assembly of claim 1, wherein said base includes a main structure to allow said first choke disposed on said upper surface and said second choke disposed on said lower surface.

10. The assembly of claim 9, wherein said base includes two pairs of pins separated from each other.

11. An integrated choke assembly, comprising:
a base, wherein a first protruding portion is on an upper surface of said base and a second protruding portion is on a lower surface of said base;
a first choke configured on said first protruding portion so that said first choke is configured on said upper surface of said base; and
a second choke configured on said second protruding portion so that said second choke is configured on said lower surface of said substrate;
wherein said first choke includes a first magnetic core and a first winding set wound on said first magnetic core, and said second choke includes a second magnetic core and a second winding set wound on said second magnetic core.

12. The assembly of claim 11, wherein said first choke is a high-frequency EMI suppression choke.

13. The assembly of claim 11, wherein said first choke is a low-frequency EMI suppression choke.

14. The assembly of claim 11, wherein said second choke is a high-frequency EMI suppression choke.

15. The assembly of claim 11, wherein said second choke is a low-frequency EMI suppression choke.

16. The assembly of claim 11, wherein said base includes two pairs of pins separated from each other.

17. The assembly of claim 11, wherein said first magnetic core is an annular first magnetic core and said second magnetic core is an annular second magnetic core.

18. The assembly of claim 11, wherein said base includes a main structure to allow said first choke disposed on said upper surface and said second choke disposed on said lower surface.

19. The assembly of claim 11, wherein a coil interval of said first winding set wound on said first magnetic core are the same.

20. The assembly of claim 11, wherein a coil interval of said second winding set wound on said second magnetic core are the same.
